(19) United States
(12) Patent Application Publication
(10) Pub. No.: US 2014/0360824 A1
(43) Pub. Date: Dec. 11, 2014

(54) ELASTICALLY DEFORMABLE ENERGY MANAGEMENT ARRANGEMENT AND METHOD OF MANAGING ENERGY ABSORPTION

(71) Applicant: GM GLOBAL TECHNOLOGY OPERATIONS LLC, Detroit, MI (US)

(72) Inventors: Steven E. Morris, Fair Haven, MI (US); Randy A. Johnson, Brighton, MI (US); Jennifer P. Lawall, Waterford, MI (US)

(21) Appl. No.: 13/915,132

(22) Filed: Jun. 11, 2013

(51) Int. Cl. F16F 7/08

(52) U.S. Cl. CPC F16F 7/087
USPC 188/268

(57) ABSTRACT

An elastically deformable energy management arrangement includes a first component comprising a first surface and a second surface. Also included is a protrusion extending from the second surface of the first component and having an outer surface, the protrusion at least partially formed of an elastically deformable material. Further included is a second component in slideable engagement with the outer surface of the protrusion and spaced from the second surface of the first component.

### FIELD OF THE INVENTION

The invention relates to energy management arrangements for managing energy absorption in response to a load and, more particularly, to an elastically deformable energy management arrangement, as well as a method of managing energy absorption.

### BACKGROUND

Efforts to manage or absorb energy are widespread in numerous industries. A vehicle zone is an example of an application in which energy absorption is emphasized. Currently, components may be disposed in close proximity with an energy absorbing component in an attempt to absorb energy. The components may be mated to each other in a manufacturing process and are subject to positional variation based on the mating arrangements between the components. The arrangement may include components mutually located with respect to each other by 2-way and/or 4-way male alignment features; typically undersized structures which are received into corresponding oversized female alignment features such as apertures in the form of openings and/or slots. There may be a clearance between at least a portion of the alignment features which is predetermined to match anticipated size and positional variation tolerances of the mating features as a result of manufacturing (or fabrication) variances. As a result, poor fit may occur, thereby leading to less efficient energy absorption during contact between components.

### SUMMARY OF THE INVENTION

In one exemplary embodiment, an elastically deformable energy management arrangement includes a first component comprising a first surface and a second surface. Also included is a protrusion extending from the second surface of the first component and having an outer surface, the protrusion at least partially formed of an elastically deformable material. Further included is a second component in slideable engagement with the outer surface of the protrusion and spaced from the second surface of the first component.

In another exemplary embodiment, a method of managing energy is provided. The method includes engaging an outer surface of a protrusion of a first component with a second component. The method also includes elastically deforming the protrusion proximate the outer surface upon engagement with the second component. The method further includes translating the protrusion upon contact of a first surface of the first component, wherein a gap between the second component and a second surface of the first component is reduced upon translation of the protrusion.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a cross-sectional view of an elastically deformable energy management arrangement in a first condition according to a first embodiment;

FIG. 2 is a cross-sectional view of the elastically deformable energy management arrangement in a second condition according to the first embodiment of FIG. 1;

FIG. 3 is a cross-sectional view of the elastically deformable energy management arrangement according to a second embodiment;

FIG. 4 is a cross-sectional view of the elastically deformable energy management arrangement according to a third embodiment;

FIG. 5 is a cross-sectional view of the elastically deformable energy management arrangement according to a fourth embodiment;

FIG. 6 is a cross-sectional view of the elastically deformable energy management arrangement in a first condition according to a fifth embodiment;

FIG. 7 is a cross-sectional view of an elastically deformable energy management arrangement in a second condition according to the fifth embodiment of FIG. 6; and

FIG. 8 is a flow diagram illustrating a method of managing energy with the elastically deformable energy management arrangement.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

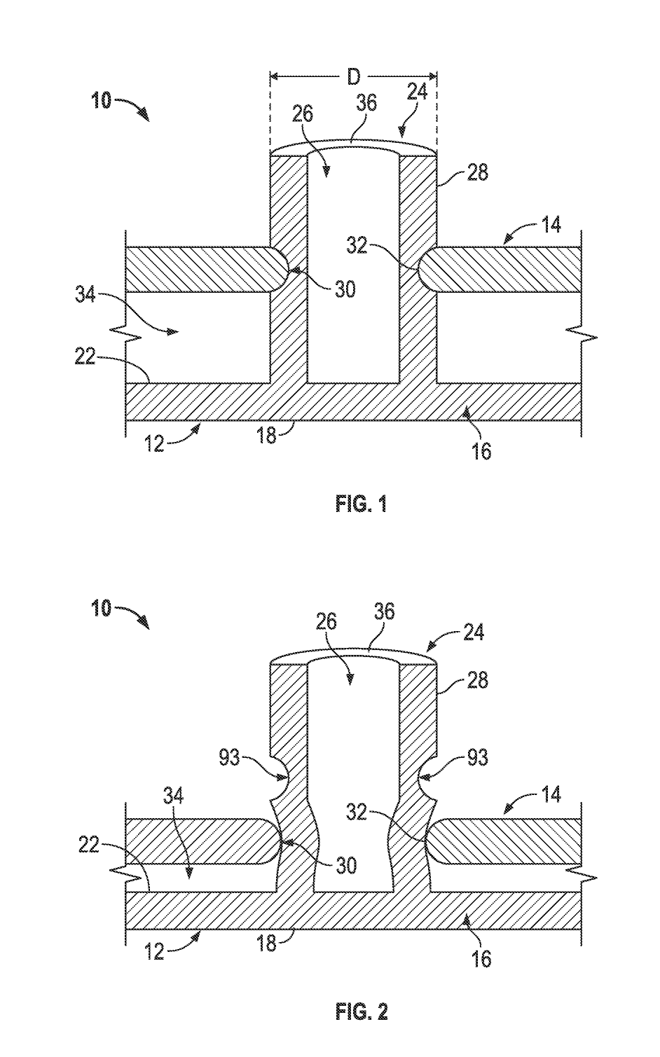

Referring to FIGS. 1 and 2, illustrated is an elastically deformable energy management assembly 10. The elastically deformable energy management assembly 10 comprises matable components, such as a first component 12 and a second component 14 that may be disposed in a mated configuration with respect to each other. In one embodiment, the elastically deformable energy management assembly 10 is employed in a vehicle application, however, it is to be understood that the components may be associated with numerous other applications and industries that benefit from energy management, such as home appliance and aerospace applications, for example. In an exemplary embodiment, energy management refers to absorption of energy in response to a load or contact, directly or indirectly, on the first component 12. In a vehicle application, the elastically deformable energy management assembly 10 may be disposed proximate a potential contact zone to absorb energy. A contact zone may refer to any location that is susceptible to being contacted by another object, such as areas proximate an occupant's knees or head, for example. However, it is to be appreciated that a contact zone does not require occupant contact, as contact may occur between vehicle components.

The elastically deformable energy management assembly 10 is illustrated in distinct conditions which will be described in detail below. In the illustrated embodiment, the first component 12 comprises a main portion 16 that includes a first surface 18. The first surface 18 is exposed to a potential contact zone and may be referred to as an contact surface. The main portion 16 also includes a second surface 22 oppositely disposed from the first surface 18. Extending from the main portion 16, and more specifically from the second surface 22, is a protrusion 24. The protrusion 24 may be formed in numerous alternate geometries, such as in the illustrated substantially circular cross-section. In one embodiment, the protrusion 24 comprises a tubular member that includes a hollow portion 26, which increases the deformability of the protrusion 24, the deformability of which is described in greater detail below. Irrespective of the precise geometry, the protrusion 24 includes an outer surface 28 that forms a protrusion perimeter and a protrusion diameter in the case of a circular cross-section.

The second component 14 is configured to engage in a tight, mated relationship with the protrusion 24 of the first component 12. The protrusion 24 is disposed within an aperture 30 defining an aperture wall 32 of the second component 14 to ensure a fitted engagement between the second component 14 and the outer surface 28 of the protrusion 24. The aperture wall 32 comprises an aperture width or perimeter that is smaller than the respective perimeter or diameter “D” of the protrusion 24. The tight, mated arrangement of the first component 12 and the second component 14 is facilitated by the elastically deformable nature of the protrusion 24 of the first component 12, which accounts for positional variation of the components that is inherently present due to manufacturing processes.

As shown in FIG. 1, in an engaged condition the second component 14 is spaced from the second surface 22 of the main portion 16 of the first component 12, thereby forming a gap 34. The elastically deformable material of the protrusion 24 provides malleability of the protrusion 24, thereby allowing the protrusion 24 to slide relative to the aperture wall 32 of the second component 14. In this way, the second component 14 is in slideable engagement with the outer surface 28 of the protrusion 24. Specifically, the second component 14, and more particularly the aperture wall 32, remains in constant, tight contact with the outer surface 28 of the protrusion 24 during relative translation between the first component 12 and the second component 14.

In operation, the first component 12 is configured to translate upon being impacted by an object (not illustrated) or force with the first surface 18. Energy associated with the contact is transferred to, and absorbed by, the second component 14 that is in contact with the protrusion 24. As the first component 12 translates from a first position (FIG. 1) to a second position (FIG. 2), the gap 34 between the second component 14 and the second surface 22 of the main portion 16 of the first component 12 is reduced. It is to be appreciated that the distance translated by the first component 12, and thus the amount of reduction of the gap 34, will vary and is determined by the force of the contact on the first surface 18 of the first component 12.

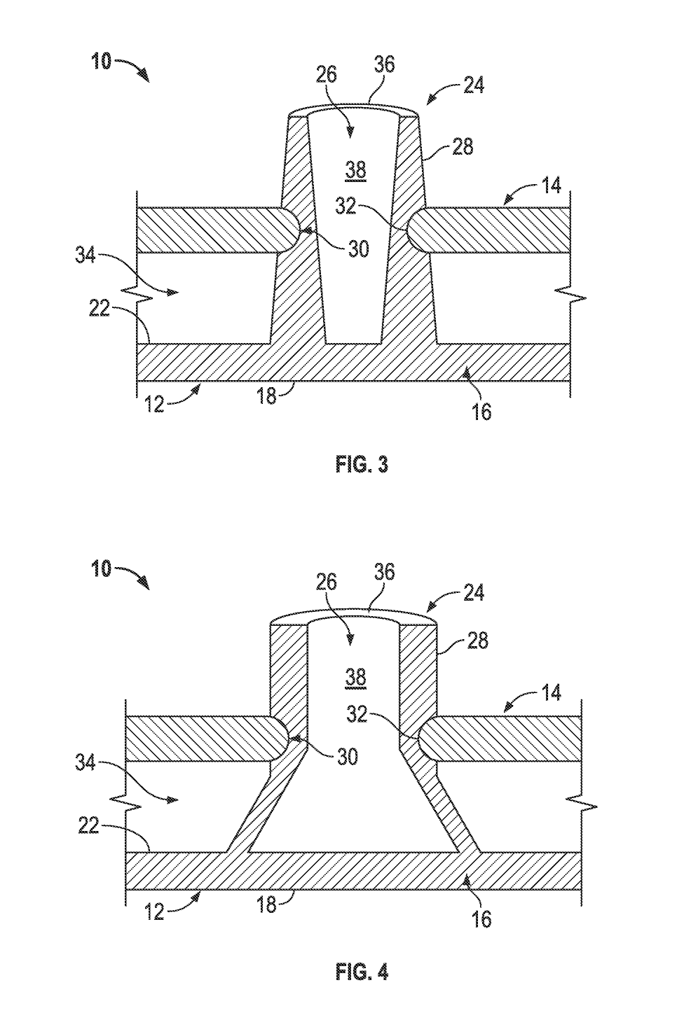

Referring to FIGS. 3-5, alternative embodiments of the protrusion 24 are illustrated. The embodiments are similar in many respects to the embodiment described in detail above, such that duplicative description of several features of the elastically deformable energy management assembly 10 is not necessary. Additionally, similar reference numerals are employed, where applicable. The alternative embodiments depict various configurations for the outer surface 28 of the protrusion 24. Specifically, all or a portion of the outer surface 28 is angled.

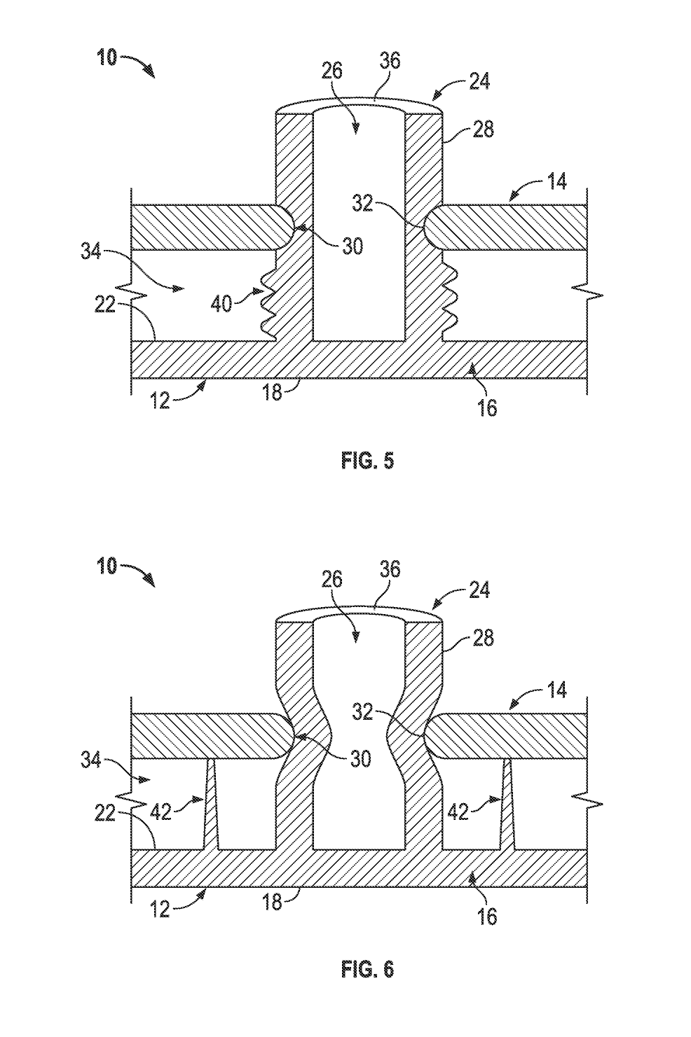

As shown in FIG. 3, the entire length of the outer surface 28 of the protrusion 24 may be angled outwardly as the outer surface 28 extends from a first end 36 toward the second surface 22 of the main portion 16 of the first component 12. In an embodiment comprising a tubular protrusion 24 having a hollow portion, an inner surface 38 may angle inwardly as the inner surface 38 extends from the first end 36 toward the second surface 22. Such a feature may be an alternative or used in combination with the outwardly angled outer surface 28 described above. Regardless, the cross-sectional area of the protrusion increases at regions closer in proximity to the second surface 22 of the first component 12. As illustrated in FIG. 4, in an alternative embodiment only a portion of the outer surface 28 of the protrusion 24 is angled outwardly. Yet another embodiment includes a plurality of ridges 40 (FIG. 5) along a least a portion of the outer surface 28 of the protrusion 24 that the aperture wall 32 of the second component 14 may reside within. The plurality of ridges 40 provides an obstruction to relative motion between the first component 12 and the second component 14. In particular, sliding only occurs upon a sufficient force imposed on the first component 12. The elastically deformable nature of the plurality of ridges 40 efficiently absorbs energy during the relative sliding process.

Each embodiment described above in conjunction with FIGS. 1-5 includes an energy management feature 93. The energy management feature 93 comprises a detent formed in the outer surface 28 of the protrusion 24. The second component 14 is shaped to substantially rest within the energy management feature 93 in an engaged, initial condition. Disposal of the second component 14 within the energy management feature 93 resists relative movement between the first component 12 and the second component 14 in response to relatively minor contacts on the first component 12. A contact generating a threshold force results in movement of the first component 12 relative to the second component 14 after forcing the second component 14 out of the energy management feature 93.

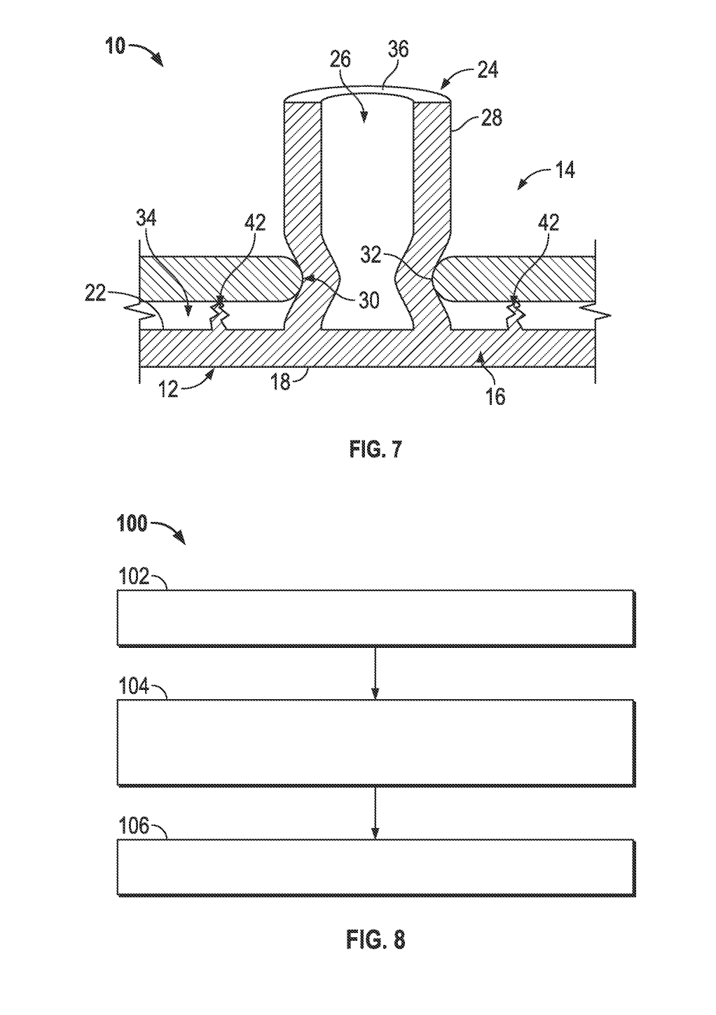

Referring now to FIGS. 6 and 7, yet another embodiment is illustrated. Included is at least one standoff 42 that is operatively coupled to the second surface 22 of the first component 12. The at least one standoff 42 extends away from the second surface 22 toward the second component 14. In a first condition (FIG. 6), the at least one standoff 42 is disposed in close proximity, or even contact, with the second component 14. As described in detail above, the first component 12 is configured to translate and upon doing so, the at least one standoff 42 is deformed, or crushed, as the first component 12 translates to a second condition (FIG. 7) in response to being impacted by an object. The at least one standoff 42 assists in energy absorption during such an event. The at least one standoff 42 performs a similar function as that of the energy management feature 93 described in detail above. Specifically, a threshold force must be imparted on the first component 12 to initiate relative motion between the first component 12 and the second component 14.

Any suitable elastically deformable material may be used for the protrusion 24. This includes various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the protrusion 24. The predetermined elastic response characteristic may include, for example, a predetermined elastic modulus.

Each of the embodiments described above include elastic deformation of the protrusion 24 while engaged with the second component 14 in the fully engaged position. The elastic deformation of the protrusion occurs predominantly proximate a location in engagement with the aperture wall 32 of the second component 14. This elastic deformation may be elastically averaged to account for any positional errors of the first component and the second component 14. In other words, gaps and/or misalignment that would otherwise be present due to positional errors associated with portions or segments of the first component 12 and the mating component 14, particularly locating and retaining features. Specifically, the positional variance of regions of the portion engaged with the aperture wall 32 is offset by the remainder of the engagement portion that is being compressed by the second component 14. In other words, the deformation along the outer surface 28 is averaged in aggregate. The principles of elastic averaging are described in detail in commonly owned, co-pending U.S. patent application Ser. No. 13/187,675, the disclosure of which is incorporated by reference herein in its entirety.

In one embodiment the elastically deformable energy management assembly 10 includes a plurality of protrusions configured to engage a plurality of apertures. In such an embodiment, the elastic deformation of each of the plurality of protrusions is averaged in aggregate relative to each other, in accordance with the principles referenced above.

A method of managing energy absorption 100 is also provided, as illustrated in FIG. 8, and with reference to FIGS. 1-7. The elastically deformable management assembly 10, and more specifically the elastically deformable nature of the protrusion 24, has been previously described and specific structural components need not be described in further detail. The method 100 includes engaging 102 the outer surface 28 of the protrusion 24 with the second component 14. The protrusion 24 is elastically deformed 104 proximate the outer surface 28 upon engagement with the second component 14. The method 100 also includes translating 106 the protrusion 24 upon contact of the first surface 18 of the first component 12, wherein the gap 34 between the second component 14 and the second surface 28 of the first component 12 is reduced upon translation of the protrusion 24.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically deformable energy management arrangement comprising:
a first component comprising a first surface and a second surface;
a protrusion extending from the second surface of the first component and having an outer surface, the protrusion at least partially formed of an elastically deformable material; and
a second component in slideable engagement with the outer surface of the protrusion and spaced from the second surface of the first component.

2. The elastically deformable energy management arrangement of claim 1, wherein the protrusion is disposed within an aperture of the second component.

3. The elastically deformable energy management arrangement of claim 2, wherein the outer surface of the first component is in slideable engagement with an aperture wall of the second component.

4. The elastically deformable energy management arrangement of claim 1, wherein the second component is spaced a first distance from the second surface of the first component in a first position of the first component.

5. The elastically deformable energy management arrangement of claim 4, wherein the second component is spaced a second distance from the second surface of the first component in a second position of the first component, wherein the first distance is greater than the second distance, and wherein energy is absorbed by the second component upon relative motion between the first component and the second component.

6. The elastically deformable energy management arrangement of claim 1, wherein the first surface comprises an contact surface.

7. The elastically deformable energy management arrangement of claim 1, wherein the protrusion comprises an angled portion extending outwardly as the outer surface extends toward the second surface of the first component.

8. The elastically deformable energy management arrangement of claim 1, wherein the protrusion comprises a tubular member.

9. The elastically deformable energy management arrangement of claim 1, wherein the second component remains in a contact interference condition with the outer surface of the protrusion over a range of positions of the first component.

10. The elastically deformable energy management arrangement of claim 1, wherein the first component comprises at least one standoff extending away from the second surface into close proximity with the second component.

11. The elastically deformable energy management arrangement of claim 10, wherein the at least one standoff is configured to deform upon translation of the first component in an contact condition to absorb energy during deformation of the at least one standoff.

12. The elastically deformable energy management arrangement of claim 1, wherein the outer surface of the protrusion comprises a plurality of ridges configured to absorb energy upon relative motion between the first component and the second component.

13. The elastically deformable energy management arrangement of claim 1, further comprising a plurality of protrusions of the first component disposed within a plurality of apertures of the second component.

14. The elastically deformable energy management arrangement of claim 13, wherein an amount of deformation of each of the plurality of protrusions is averaged in aggregate.

15. The elastically deformable energy management arrangement of claim 1, wherein the elastically deformable energy management arrangement is disposed in a vehicle.

16. A method of managing energy absorption comprising:
engaging an outer surface of a protrusion of a first component with a second component;
elastically deforming the protrusion proximate the outer surface upon engagement with the second component; and
translating the protrusion upon contact of a first surface of the first component, wherein a gap between the second component and a second surface of the first component is reduced upon translation of the protrusion.

17. The method of claim 16, wherein elastically deforming the protrusion comprises disposing the protrusion within an aperture of the second component and compressing the outer surface with an aperture wall of the second component.

18. The method of claim 16, further comprising engaging a plurality of protrusions with a plurality of apertures and elastically deforming the plurality of protrusions.

19. The method of claim 18, further comprising performing an elastic averaging of the amount of deformation of each of the plurality of protrusions.

20. The method of claim 16, further comprising compressing at least one standoff extending away from the second surface into close proximity with the second component.
